(19) United States
(12) Patent Application Publication
(10) Pub. No.: US 2025/0086503 A1
(43) Pub. Date: Mar. 13, 2025

(54) DISTRIBUTED MODEL TRAINING BASED ON NODE FAULT PERCEPTION

(71) Applicant: ZHEJIANG LAB, Hangzhou City (CN)

(72) Inventors: Guang CHEN, Hangzhou City (CN); Yong LI, Hangzhou City (CN); Shiqiang ZHU, Hangzhou City (CN)

(73) Assignee: ZHEJIANG LAB, Hangzhou City, ZJ (CN)

(21) Appl. No.: 18/580,048

(22) PCT Filed: Oct. 12, 2023
(86) PCT No.: PCT/CN2023/124333

§ 371 Date: Jan. 17, 2024

(30) Foreign Application Priority Data
Aug. 21, 2023 (CN) 202311053457.4

(51) Int. Cl. G06N 20/00

(52) U.S. Cl. CPC G06N 20/00

(57) ABSTRACT

The present disclosure discloses a method and an apparatus for training a distributed model based on node fault perception, a storage medium, and an electronic device. During model training, a backup node can be assigned to each device node used during model training, such that in response to monitoring that a device node is faulty, the backup node corresponding to the faulty device node can take over the model training task, thereby ensuring the efficiency of the model training task.

### CROSS REFERENCE TO RELATED APPLICATIONS

This application is a US National Phase of a PCT Application No. PCT/CN2023/124333 filed on Oct. 12, 2023, which claims priority to Chinese Patent Application No. 2023110534574 filed on Aug. 21, 2023, the entire contents of which are incorporated herein by reference in their entireties.

### TECHNICAL FIELD

The present disclosure relates to the field of computer technology, particularly to a method and an apparatus for training a distributed model based on node fault perception, a storage medium, and an electronic device.

### BACKGROUND

With the development of technology, more and more artificial intelligence models that can be practically applied to help improve people's production and life have emerged, promoting the development of modern society and the progress of human society.

To improve the performances of the models, the models need to be trained. As a parameter scale of a model increases, and the computing power of a single device node is too low to complete a training task for a model with larger parameter scale alone, the model that needs to be trained will be divided into multiple segments, each segment will be assigned to a device node, and these device nodes will jointly complete the distributed training of the model. However, typical distributed training methods cannot continue to perform model training tasks after a node failure, which can cause interruptions in the model training task.

Therefore, how to ensure the continuity of model training and improve the efficiency of model training without interrupting model training due to a single node failure is an urgent problem that needs to be solved.

### SUMMARY

The present disclosure provides a method and an apparatus for training a distributed model based on node fault perception, a storage medium, and an electronic device, to partially solve the above-mentioned problems existing in the prior art.

The present disclosure adopts following technical solutions.

The present disclosure provides a method for training a distributed model based on node fault perception, including:

determining a target model to be trained and dividing the target model into sub-models:

deploying the sub-models respectively in device nodes to perform a model training task for the target model through the device nodes:

in response to monitoring that the model training task for the target model is abnormal during execution, determining a faulty node from the device nodes, and determining an execution progress when the model training task for the target model is abnormal as a first progress:

determining a backup node for the faulty node, and continuing to execute, by the backup node, a model training task for a sub-model deployed in the faulty node from the first progress: and
monitoring whether the faulty node returns to normal within a set period:

in response to determining that the faulty node returns to normal within the set period, determining an execution progress of the backup node executing the model training task for the sub-model deployed in the faulty node when the faulty node returns to normal as a second progress, and continuing to execute, by the faulty node, the model training task for the sub-model deployed in the faulty node from the second progress:

in response to determining that the faulty node does not return to normal within the set period, re-dividing the target model according to the number of normal device nodes to obtain re-divided sub-models, and deploying the re-divided sub-models respectively in the normal device nodes, to perform the model training task for the target model.

In some embodiments, monitoring that the model training task for the target model is abnormal during execution includes:

monitoring whether heartbeat signals from the device nodes are received at default time intervals:

in response to determining that a heartbeat signal transmitted by at least one of the device nodes is not received within a designated period, determining that the model training task for the target model is abnormal during execution, and determining a device node that does not transmit a heartbeat signal within the designated period as a faulty node.

In some embodiments, determining the backup node for the faulty node, and continuing to execute, by the backup node, the model training task for the sub-model deployed in the faulty node from the first progress includes:

transmitting a start signal to the backup node corresponding to the faulty node, such that after receiving the start signal, the backup node corresponding to the faulty node reads out the sub-model deployed in the faulty node that is locally pre-stored in the backup node, and continues to execute the model training task for the sub-model deployed in the faulty node from the first progress.

In some embodiments, determining the execution progress of the backup node executing the model training task for the sub-model deployed in the faulty node when the faulty node returns to normal as a second progress, and continuing to execute, by the faulty node, the model training task for the sub-model deployed in the faulty node from the second progress includes:

in response to determining that the faulty node returns to normal, according to execution progress information of the model training task for the target model carried by the heartbeat signal transmitted by the backup node, determining the execution progress of the backup node executing the model training task for the sub-model deployed in the faulty node, as the second progress:

transmitting model data of the sub-model deployed in the backup node to the faulty node, such that the faulty node updates a sub-model deployed in the faulty node according to the model data; and

transmitting a restart signal to the faulty node, such that after receiving the restart signal, the faulty node continues to execute the model training task for an updated sub-model deployed in the faulty node from the second progress.

In some embodiments, re-dividing the target model according to the number of the normal device nodes to obtain the re-divided sub-models, and deploying the re-divided sub-models respectively in the normal device nodes includes:

re-dividing the target model according to the number of the normal device nodes, to obtain a dividing result;

for each of the normal device nodes, based on the dividing result, determining a network layer in the target model that needs to be migrated to the device node as a supplementary network layer corresponding to the device node, and determining a current device node where the supplementary network layer corresponding to the device node is currently located as a network layer source node corresponding to the device node; and

based on the supplementary network layer corresponding to each of the normal device nodes and the network layer source node corresponding to each of the normal device nodes, adjusting a network layer currently contained in each of the normal device nodes, to deploy the re-divided sub-models respectively to the normal device nodes.

In some embodiments, the backup node is a predecessor node for the faulty node, and the predecessor node is configured to transmit a result of a forward calculation to the faulty node after completing the forward calculation of the sub-model deployed to the predecessor node.

The present disclosure provides an apparatus for training a distributed model based on node fault perception, including:

a determining module, configured to determine a target model to be trained and dividing the target model into sub-models:

a deploying module, configured to deploy the sub-models respectively in device nodes to perform a model training task for the target model through the device nodes:

a fault determining module, configured to, in response to monitoring that the model training task for the target model is abnormal during execution, determine a faulty node from the device nodes, and determine an execution progress when the model training task for the target model is abnormal as a first progress;

a replacing module, configured to determine a backup node for the faulty node, continue to execute, by the backup node, a model training task for a sub-model deployed in the faulty node from the first progress, and monitor whether the faulty node returns to normal within a set period: and

a recovering and dividing module, configured to, in response to determining that the faulty node returns to normal within the set period, determine an execution progress of the backup node executing the model training task for the sub-model deployed in the faulty node when the faulty node returns to normal as a second progress, and continue to execute, by the faulty node, the model training task for the sub-model deployed in the faulty node from the second progress; in response to determining that the faulty node does not return to normal within the set period, re-divide the target model according to the number of normal device nodes to obtain re-divided sub-models, and deploy the re-divided sub-models respectively in the normal device nodes, to perform the model training task for the target model.

In some embodiments, the fault determining module is configured to monitor whether heartbeat signals from the device nodes are received at default time intervals; in response to determining that a heartbeat signal transmitted by at least one of the device nodes is not received within a designated period, determine that the model training task for the target model is abnormal during execution, and determine a device node that does not transmit a heartbeat signal within the designated period as a faulty node.

In some embodiments, the replacing module is configured to transmit a start signal to the backup node corresponding to the faulty node, such that after receiving the start signal, the backup node corresponding to the faulty node reads out the sub-model deployed in the faulty node that is locally pre-stored in the backup node, and continues to execute the model training task for the sub-model deployed in the faulty node from the first progress.

In some embodiments, the recovering and dividing module is configured to, in response to determining that the faulty node returns to normal, according to execution progress information of the model training task for the target model carried by the heartbeat signal transmitted by the backup node, determine the execution progress of the backup node executing the model training task for the sub-model deployed in the faulty node, as the second progress; transmit model data of the sub-model deployed in the backup node to the faulty node, such that the faulty node updates a sub-model deployed in the faulty node according to the model data; and transmit a restart signal to the faulty node, such that after receiving the restart signal, the faulty node continues to execute the model training task for an updated sub-model deployed in the faulty node from the second progress.

In some embodiments, the recovering and dividing module is configured to re-divide the target model according to the number of the normal device nodes, to obtain a dividing result; for each of the normal device nodes, based on the dividing result, determine a network layer in the target model that needs to be migrated to the device node as a supplementary network layer corresponding to the device node, and determine a current device node where the supplementary network layer corresponding to the device node is currently located as a network layer source node corresponding to the device node; and based on the supplementary network layer corresponding to each of the normal device nodes and the network layer source node corresponding to each of the normal device nodes, adjust a network layer currently contained in each of the normal device nodes, to deploy the re-divided sub-models respectively to the normal device nodes.

In some embodiments, the backup node is a predecessor node for the faulty node, and the predecessor node is configured to transmit a result of a forward calculation to the faulty node after completing the forward calculation of the sub-model deployed to the predecessor node.

The present disclosure provides a computer-readable storage medium that stores computer programs. When the computer programs are executed by a processor, the method for training a distributed model based on node fault perception is implemented.

The present disclosure provides an electronic device, including a memory, a processor and a computer program stored on the memory and runnable on the processor, where the processor when executing the program, implements the method for training a distributed model based on node fault perception.

At least one of the above technical solutions adopted in the present application can achieve the following beneficial effects.

The method for training a distributed model based on node fault perception provided in the present disclosure includes: determining a target model to be trained and dividing the target model into sub-models; deploying the sub-models respectively in device nodes to perform a model training task for the target model through the device nodes; in response to monitoring that the model training task for the target model is abnormal during execution, determining a faulty node from the device nodes, and determining an execution progress when the model training task for the target model is abnormal as a first progress; determining a backup node for the faulty node, and continuing to execute, by the backup node, a model training task for a sub-model deployed in the faulty node from the first progress; and monitoring whether the faulty node returns to normal within a set period; in response to determining that the faulty node returns to normal within the set period, determining an execution progress of the backup node executing the model training task for the sub-model deployed in the faulty node when the faulty node returns to normal as a second progress, and continuing to execute, by the faulty node, the model training task for the sub-model deployed in the faulty node from the second progress; in response to determining that the faulty node does not return to normal within the set period, re-dividing the target model according to the number of normal device nodes to obtain re-divided sub-models, and deploying the re-divided sub-models respectively in the normal device nodes, to perform the model training task for the target model.

From the above methods, it can be seen that during model training, a backup node can be assigned to each device node used during model training, such that in response to monitoring that a device node is faulty, the backup node corresponding to the faulty device node can take over the model training task, thereby ensuring the efficiency of the model training task.

### BRIEF DESCRIPTION OF DRAWINGS

The accompanying drawings illustrated herein are used to provide further understanding of the present disclosure and form a part of the present disclosure. The exemplary embodiments and descriptions of the present disclosure are used to explain the present disclosure, and do not constitute an improper limitation of the present disclosure.

FIG. 1 is a flowchart of a method for training a distributed model based on node fault perception provided in the present disclosure.

FIG. 2 is a schematic diagram of operation content of manager modules provided in the present disclosure.

FIG. 3 is a schematic diagram of an operation manner of manager modules provided in the present disclosure.

FIG. 4 is a schematic flow chart of replacing a faulty node provided in the present disclosure.

FIG. 5 is a structural schematic diagram of an apparatus for training a distributed model based on node fault perception provided in the present disclosure.

FIG. 6 is a structural schematic diagram of an electronic device corresponding to FIG. 1 provided in the present disclosure.

### DETAILED DESCRIPTION

In order present the purposes, technical solutions and advantages of the present disclosure clearer, the technical solutions of the present disclosure will be clearly and completely described below in conjunction with specific embodiments and corresponding drawings of the present disclosure. The described embodiments are only a part of the embodiments of the present disclosure, and not all of them. Other embodiments achieved by those skilled in the art based on the embodiments in the present disclosure without paying creative work shall all fall within the scope of protection of the present disclosure.

The technical solutions provided in the embodiments of the present disclosure are described in detail below in conjunction with the accompanying drawings.

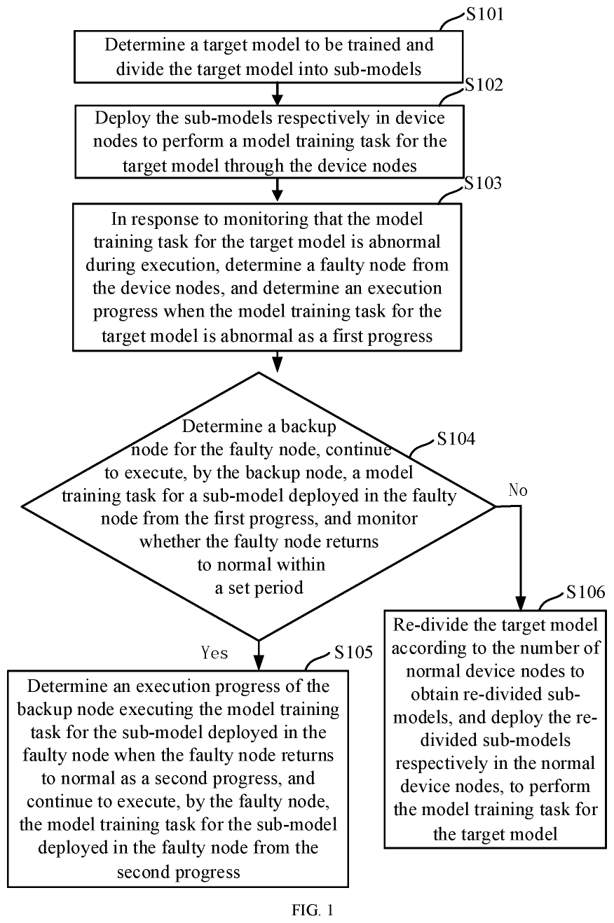

FIG. 1 is a flowchart of a method for training a distributed model based on node fault perception provided in the present disclosure. The method includes the following steps S101-S106.

In S101, a target model to be trained is determined and the target model is divided into sub-models.

The execution subject of the method for training a distributed model based on node fault perception mentioned in the present disclosure can be a terminal device such as a desktop, a laptop, or a server. The following only uses the terminal device as the execution subject as an example to describe the method of training a distributed model based on node failure perception in the embodiments of the present disclosure.

Usually, model training of the target model can use distributed training, that is, multiple device nodes jointly train a target model. For example, first, the target model is divided into sub-models and these sub-models are respectively deployed to device nodes to jointly complete the training task of the target model through these device nodes. However, the usual distributed training of the target model cannot continue to execute the task of training the target model after a device node failure, resulting in the interruption of the target model training task and reducing the training efficiency of the target model.

In the present disclosure, when the terminal device divides the target model to obtain sub-models, for example, the target model can be divided based on the number of current device nodes, where dividing here can refer to dividing the network layers in the target model into several groups, and each group of network layers forms a sub-model.

For example, if the target model contains a total of 1000 network layers, and there are 5 device nodes used to train the target model, the terminal device can divide the target model into 5 groups to obtain sub-models. Each group has 200 network layers. For example, the first group contains the 1st-200th network layers of the target model, the second group contains the 201 st-400th network layers of the target model, and so on, such that the network layers of each group form a sub-model. It can be seen that the network layers of each group divided here do not overlap with each other.

It should be noted that the terminal device mentioned here may not be device nodes participating in the model training of the target model. In other words, the terminal device can only be used to divide the target model and transmit data of the divided sub-models to multiple device nodes, such that each device node can perform the task of training the sub-model in that device node, and the terminal device can further monitor the status of each device node during the execution of the model training task, that is, the terminal device can be used to coordinate and command the model training task of the target model. In some embodiments, the terminal device mentioned here can also be a device node participating in the training of the target model. In addition to participating in the training of the target model, the terminal device further needs to be responsible for coordinating and commanding the model training task of the target model.

In S102, the sub-models are deployed respectively in device nodes to perform a model training task for the target model through the device nodes.

In S103, in response to monitoring that the model training task for the target model is abnormal during execution, a faulty node is determined from the device nodes, and an execution progress when the model training task for the target model is abnormal is determined as a first progress.

In the present disclosure, when the model training task of the sub-model deployed in each device node is executed through the device node, the status of each device node can be monitored in real-time through a preset master manager module. For example, the master manager module can monitor whether heartbeat signals from the device nodes are received at default time intervals: in response to determining that a heartbeat signal transmitted by at least one of the device nodes is not received within a designated period, determine that the model training task for the target model is abnormal during execution, and determine a device node that does not transmit a heartbeat signal within the designated period as a faulty node.

For example, during the model training process of the target model, each device node transmits a heartbeat signal to the master manager module every default time interval of 30 seconds. If the master manager module does not receive a heartbeat signal from a device node within the designated period of 2 minutes, it can be determined that there is an fault in the model training task of the target model during execution, and the device node that did not transmit the heartbeat signal within the designated period of 2 minutes is determined as the faulty node.

When a fault occurs during the execution of the model training task for the target model, the master manager module can further determine the execution progress of the model training task for the target model based on the execution progress information carried by the heartbeat signals transmitted to the master manager module by other device nodes except the faulty node, as the first progress.

The execution progress here can be used to represent an execution stage of executing the model training task of the target model, which can be expressed in many forms. For example, the model training task of the target model is executed by inputting samples one by one, so the execution progress can be understood as the number of samples input to perform the task of model training of the target model.

For example, during a certain round of model training, the device nodes need to use a total of 100 samples to train the target model. When it is determined that the model training task of the target model is abnormal during execution, other device nodes except the faulty node are using the 30th sample to train the target model, such that the first progress is to use the 30th sample to train the target model.

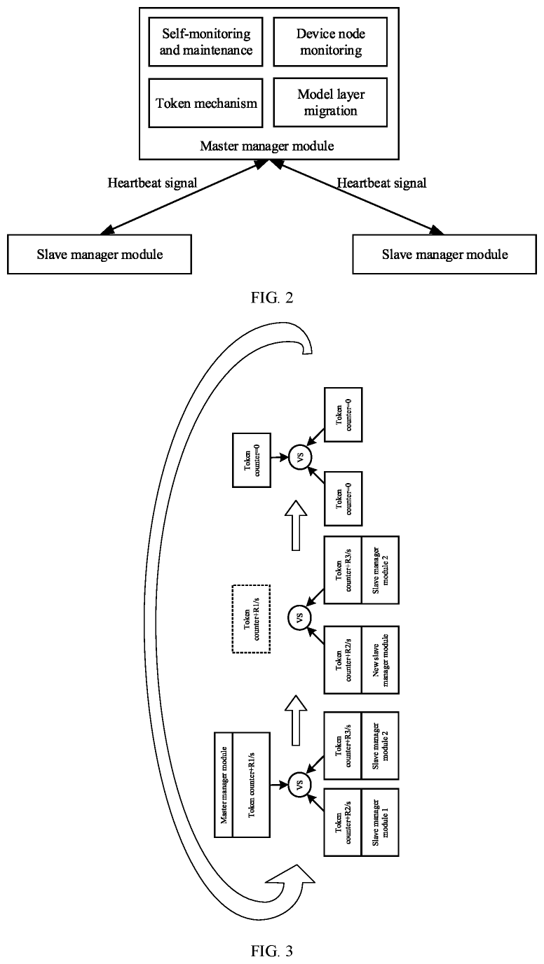

FIG. 2 is a schematic diagram of operation content of manager modules provided in the present disclosure.

As shown in FIG. 2, the main functions of the master manager module include “self-monitoring and maintenance”, “token mechanism”, “device node monitoring”, and “model layer migration”. The “self-monitoring and maintenance” of the master manager module is mainly to prevent the normal progress of distributed training from being affected by the fault of the device node where the master manager module is located. The “token mechanism” is a specific method to achieve the fast-switching function of the node where the master manager module is located, as detailed in the subsequent content of S103. “Device node monitoring” refers to the real-time monitoring of the status of each device node by the master manager module mentioned above. “Model layer migration” refers to how to deploy the re-divided sub-models to the normal device nodes mentioned in S106, as detailed in S106, which will not be repeated here. The “heartbeat signal” in FIG. 2 refers to the communication between the master manager module and the slave manager module through transmitting heartbeat signals.

The preset master manager module mentioned above can be deployed to the device nodes with sub-models participating in the training of the target model to save the cost of model training, or the master manager module can be deployed to other device nodes that do not participate in the training of the target model, such as the terminal device mentioned above. The present disclosure does not make specific restrictions.

In order to enhance the fault tolerance of the master manager module mentioned above, and to avoid the situation where the model training method in the present disclosure cannot continue due to the fault of the device node where the master manager module is located (i.e., to achieve the “self-monitoring and maintenance” function of the manager module mentioned above), two corresponding slave manager modules can be pre-set for the master manager module. For example, the two slave manager modules can be configured to backup data in the master manager module. Once the terminal device detects a fault of the device node where the master manager module is located, the slave manager modules can take over the master manager module to continue executing the task of the master manager module. The two slave manager modules can be respectively deployed to two other device nodes except the device node where the master manager module is located.

The fault perception of the device node where the master-slave manager module is located and the switching of the master-slave manager module mentioned above can be achieved through the following methods.

The terminal device can pre-set token counters for both the master manager module and the two slave manager modules, and set different token increase speeds for each token counter. For example, the token increase speed of the manager module in the device node deployed at the back of the training pipeline of the target model can be faster. The three managers transmit their current accumulated token count to each other through heartbeat signals, and the manager module with the highest number of tokens can be specified as the master manager module.

Once the device node where the master manager module is located fails and becomes a faulty node, the number of tokens in the token counter corresponding to the master manager module will stop increasing. At the same time, the number of tokens in the token counters corresponding to other slave manager modules will continue to increase, and the number of tokens corresponding to the slave manager module will soon exceed the number of tokens corresponding to the original master manager module. Therefore, the slave manager module can replace the original master manager module as the new master manager module, continue to provide services of the master manager module, and achieve seamless switching.

And once the faulty node returns to normal and rejoins or other new manager modules join (the new manager module joining here can refer to a new device node joining, and the manager module is also deployed in the new device node), first, the number of tokens corresponding to all manager modules (including the new master manager module, slave manager module, and newly added manager module mentioned above) is reset to zero, to eliminate the difference in token count between the new manager module and the current manager modules, and then recalculate. Thus, in the shortest possible time, the manager module (with the highest number of tokens) on the device node located at the back of the training pipeline is re-selected as the re-selected master manager module. If the re-selected master manager module is not the original master manager module, the data from the original master manager module can be copied to the re-selected master manager module, such that the re-selected master manager module can continue to provide services of the master manager module.

FIG. 3 is a schematic diagram of an operation manner of manager modules provided in the present disclosure.

As shown in FIG. 3, the token increase speed of the token counter in the master manager module in FIG. 3 is R1/s, the token increase speed of the token counter in slave manager module 1 is R2/s, and the token increase speed of the token counter in slave manager module 2 is R3/s. Here. R1, R2, and R3 are all natural numbers, and R1>R2>R3.

When the device node where the master manager module is located fails and becomes a faulty node, the number of tokens in the token counter of the master manager module will stop increasing, as shown in the dashed box in FIG. 3. However, the number of tokens of slave manager module 1 and slave manager module 2 will still increase at the original token increase speed. Due to R2>R3, the number of tokens of slave manager module 1 is the highest, then, slave manager module 1 will become the new master manager module, continuing to provide services of the master manager module and achieving seamless switching.

And once the faulty node returns to normal and rejoins or other new manager modules join (the new manager module joining here can refer to a new device node joining, and the manager module is also deployed in the new device node), first, the number of tokens corresponding to all manager modules (including the new master manager module, slave manager module, and newly added manager module mentioned above) is reset to zero, to eliminate the difference in token count between the new manager module and the current manager modules, and then recalculate. Thus, in the shortest possible time, the manager module (with the highest number of tokens) on the device node located at the back of the training pipeline is re-selected as the re-selected master manager module. If the re-selected master manager module is not the original master manager module, the data from the original master manager module can be copied to the re-selected master manager module, such that the re-selected master manager module can continue to provide services of the master manager module.

The fault perception of the device node where the master-slave manager module is located and the switching of the master-slave manager module mentioned above may have other methods, which will not be listed in the present disclosure.

In S104, a backup node is determined for the faulty node, it is continued to execute, by the backup node, a model training task for a sub-model deployed in the faulty node from the first progress, and it is monitored whether the faulty node returns to normal within a set period.

In the present disclosure, when a fault occurs during the execution of the model training task for the target model, the backup node corresponding to the faulty node can be determined. For example, the backup node corresponding to the faulty node can be determined by the corresponding relationships between device nodes and backup nodes pre-stored in the master manager module.

Afterwards, the master manager module can continue to transmit a start signal to the backup node corresponding to the faulty node, such that after receiving the start signal, the backup node corresponding to the faulty node reads out the sub-model deployed in the faulty node that is locally pre-stored in the backup node, and continues to execute the model training task for the sub-model deployed in the faulty node from the first progress.

Continuing with the above example, when the first progress is to train the target model using the 30th sample, the aforementioned continuing to execute the model training task for the deployed sub-model in the faulty node from the first progress refers to continuing to execute the model training task for the sub-model deployed in the faulty node in the current round from the 30th sample.

At the same time, the master manager module can continue to monitor whether the faulty node returns to normal within the set period. For example, the master manager module can monitor whether the heartbeat signal transmitted by the faulty node is received within the set period. If so, it is determined that the faulty node returns to normal. Otherwise, it is determined that the faulty node does not return to normal.

In this way, during the training process of the target model, it is possible to quickly find a backup node that can replace the faulty node to continue executing the training task of the sub-model deployed in the faulty node, avoiding the situation where the entire target model training is interrupted due to a node failure, greatly improving the training efficiency of the target model.

In S105, in response to determining that the faulty node returns to normal within the set period, an execution progress of the backup node executing the model training task for the sub-model deployed in the faulty node when the faulty node returns to normal is determined as a second progress, and it is continued to execute, by the faulty node, the model training task for the sub-model deployed in the faulty node from the second progress.

In S106, in response to determining that the faulty node does not return to normal within the set period, the target model is re-divided according to the number of normal device nodes to obtain re-divided sub-models, and the re-divided sub-models is deployed respectively in the normal device nodes, to perform the model training task for the target model.

Once it is determined that the faulty node returns to normal within the set period. the master manager module can. according to execution progress information of the model training task for the target model carried by the heartbeat signal transmitted by the backup node. determine the execution progress of the backup node executing the model training task for the sub-model deployed in the faulty node. as the second progress.

Continuing with the above example, when the master manager module determines that the backup node has executed the model training task for the sub-model deployed in the faulty node to the 70th sample according to the execution progress information of the model training task for the target model carried by the heartbeat signal transmitted by the backup node. then it can be determined that the second progress is to train the target model using the 70th sample.

At this point. the model data of the sub-model deployed in the backup node can be transmitted to the faulty node through the master manager module, so that the faulty node can update a sub-model deployed in the faulty node based on the received model data.

It should be noted that only a target model training method that requires frequent parameter updates needs to update the sub-model deployed in the faulty node through the above method. If the training method is to update the parameters in the target model based on the training result of each round, because a round may not end when the faulty node returns to normal. then there is no need to update the sub-model deployed in the faulty node through the above method at this time.

Moreover, the master manager module can further transmit a restart signal to the faulty node, such that the faulty node can continue to execute the model training task for the updated sub-model deployed in the faulty node from the second progress after receiving the restart signal. Continuing with the above example, since the second progress is to train the target model using the 70th sample, the faulty node can start executing the model training task for the updated sub-model deployed in the faulty node from the 70th sample after receiving the restart signal.

On the contrary, once it is determined that the faulty node does not return to normal within the set period, the target model can be re-divided based on the number of normal device nodes using linear programming solvers such as CPLEX in the master manager module, to obtain the dividing result. The dividing result here represents the network layers included in the re-divided sub-model that each normal device node should undertake for training. The number of normal device nodes here can include the number of new device nodes added for training the target model. The content here is the “model layer migration” function of the manager module mentioned in S103 above.

Afterwards, for each of the device nodes in the normal status, based on the dividing result, a network layer in the target model that needs to be migrated to the device node can be determined as a supplementary network layer corresponding to the device node, and a current device node where the supplementary network layer corresponding to the device node is currently located can be determined as a network layer source node corresponding to the device node.

Afterwards, based on the supplementary network layer corresponding to each of the device nodes in the normal status and the network layer source node corresponding to each of the device nodes in the normal status, a network layer currently contained in each of the device nodes in the normal status is adjusted, to deploy the re-divided sub-models respectively to the device nodes in the normal status.

For example, for each device node in the normal status, the supplementary network layer and network layer source node corresponding to the determined device node in the normal status can be transmitted to the device node in the normal status, such that the device node in the normal status can transmit a request to obtain the supplementary network layer to the network layer source node, and based on the supplementary network layer transmitted by the obtained network layer source node, the network layer currently contained in the device node that is in the normal status is adjusted, and the re-divided sub-model corresponding to the device node in the normal status is deployed to the device node in the normal status, to achieve the migration of the above network layer.

For example, there are a total of 100 network layers in the target model. When it is started to train the target model, the device nodes used to complete the model training task are: device node 1, device node 2, device node 3, device node 4, and device node 5. The network layers of the target model included in the sub-model deployed in each device node are shown in Table 1.

TABLE 1

| Device Node 1 | Device Node 2 | Device Node 3 | Device Node 4 | Device Node 5 |
|---|---|---|---|---|
| Network layer | Network layer | Network layer | Network layer | Network layer |
| 1-20 | 21-40 | 41~60 | 61~80 | 81-100 |

When device node 3 is detected as a faulty node and does not returns to normal within the set period, the target model can be re-divided. The network layers of the target model included in the sub-model deployed in each device node in the normal status displayed in the dividing result are shown in Table 2.

TABLE 2

| | | Device Node 3 | | |
|---|---|---|---|---|
| Device Node 1 | Device Node 2 | (Fault) | Device Node 4 | Device Node 5 |
| Network layers | Network layer | nothing | Network layer | Network layer |
| 1-25 | 26-50 | | 51-75 | 76-100 |

Afterwards, for each device node in the normal status, based on the dividing result, the network layer of the target model that needs to be migrated to the device node is determined, as the corresponding supplementary network layer for the device node. For device node 1, it can be determined that the supplementary network layers corresponding to the device node is network layers 21-25, and the device node where the supplementary network layers are currently located is device node 2. For device node 2, it can be determined that the supplementary network layers corresponding to the device node is network layers 41-50, and the device node where the supplementary network layers are currently located is device node 3. So, device node 2 is the network layer source node corresponding to device node 1, device node 3 is the network layer source node corresponding to device node 2, and so on.

Afterwards, for device node 1, the supplementary network layers “Network Layer 21-25” corresponding to device node 1 and the device node “Device Node 2” where the supplementary network layers are currently located can be transmitted to device node 1. Device node 1 can transmit a request to obtain the supplementary network layers to device node 2. At this time, device node 2 can transmit the “Network Layer 21-25” from device node 2 to device node 1.

Device node 1 adjusts its current network layer accordingly to deploy the re-divided sub-model in device node 1. The same applies to other device nodes and will not be repeated.

In addition, the backup node mentioned above can be a predecessor node for the faulty node, and the predecessor node is configured to transmit a result of a forward calculation to the faulty node after completing the forward calculation of the sub-model deployed to the predecessor node.

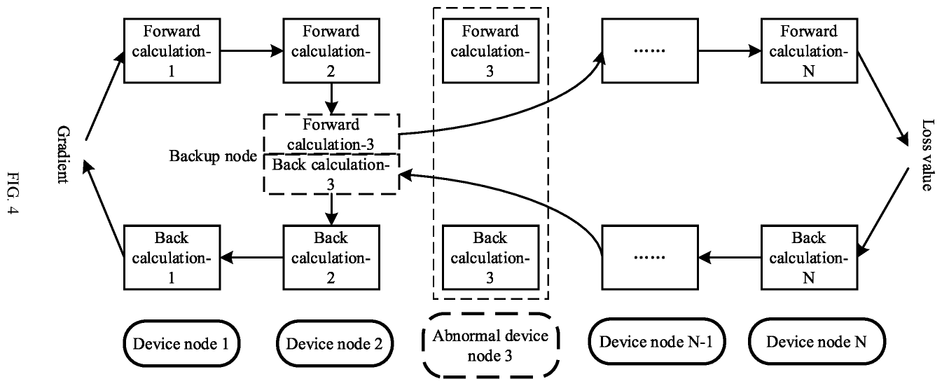

FIG. 4 is a schematic flow chart of replacing a faulty node provided in the present disclosure.

As shown in FIG. 4, when it is started to train the target model, the device nodes used to complete the model training task of the target model are: device node 1, device node 2, device node 3, . . . , device node N-1, and device node N.

When the master manager module detects that device node 3 does not transmit the heartbeat signal within 2 minutes of the designated period, it can be determined that device node 3 is the faulty node. Then, it can be determined that device node 2 is the backup node for device node 3 (where device node 2 is the predecessor node of device node 3), and it is determined that the first progress is to train the target model using the 30th sample.

During the model training process, first, the forward calculation result of the sub-model deployed in device node 2 for the 30th sample can be determined, and then the forward calculation result of the sub-model deployed in device node 3 can be determined based on the forward calculation result. Then, device node 2 can transmit the forward calculation result of the sub-model in device node 2 that is deployed in device node 3 to device node 4, and so on, until the loss value of the target model for the 30th sample is determined. Subsequent backpropagation can also be performed, and the gradient of the target model with respect to the 30th sample is determined based on a series of back calculation results, which will not be described again in this disclosure.

Afterwards, device node 2 can respond to a startup signal, read out the sub-model deployed in device node 3 that is pre-stored locally in device node 2, and continue to perform the model training task corresponding to the sub-model deployed in device node 3 from the 30th sample.

At the same time, the master manager module can continue to monitor whether the device node 3 transmits a heartbeat signal to the master manager module within the set period of 5 minutes.

If so, it is determined that device node 3 returns to normal within the set period, and the execution of the model training task corresponding to the sub-model deployed in the faulty node in device node 2 has reached the 70th sample, which is determined as the second progress. Additionally, the model data of the sub-model corresponding to device node 2 that is deployed in device node 3 can be transmitted to device node 2 through the master manager module, to enable device node 2 to update the parameters of a sub-model deployed in device node 2. Moreover, device node 2 can continue to execute the model training task corresponding to the updated sub-model deployed in device node 2 from the second progress (i.e., from the 70th sample) based on the received restart signal transmitted by the master manager module.

On the contrary, if it is determined that the faulty node does not return to normal within the set period, the target model can be re-divided based on the number of normal device nodes, to obtain the dividing result. Based on the dividing result, model layer migration can be carried out to deploy the re-divided sub-models corresponding to the normal device nodes to the normal device nodes.

From the above methods, it can be seen that during model training, a backup node can be assigned to each device node used during model training, such that in response to monitoring that a device node is faulty, the backup node corresponding to the faulty device node can take over the model training task, thereby ensuring the efficiency of the model training task.

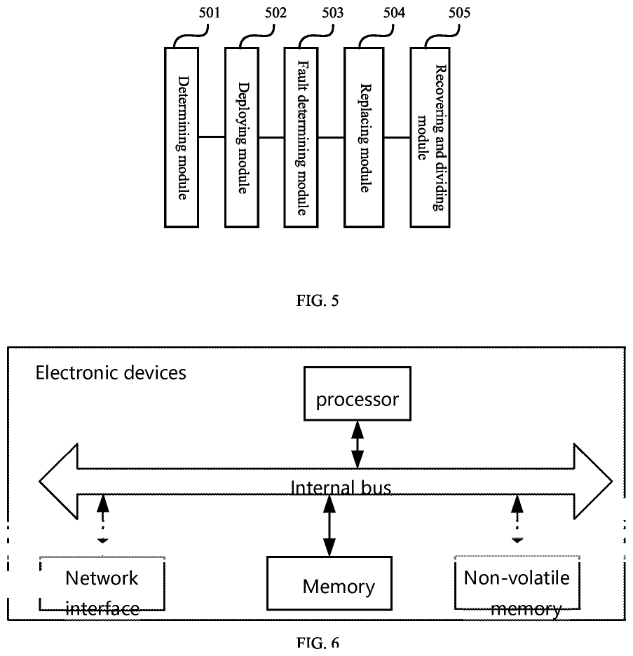

The above are methods of one or more implementation of the present disclosure. Based on the same idea, the present disclosure further provides a corresponding apparatus for training a distributed model based on node fault perception, as shown in FIG. 5.

FIG. 5 is a structural schematic diagram of an apparatus for training a distributed model based on node fault perception provided in the present disclosure. The apparatus includes:

a determining module 501, configured to determine a target model to be trained and dividing the target model into sub-models:

a deploying module 502, configured to deploy the sub-models respectively in device nodes to perform a model training task for the target model through the device nodes:

a fault determining module 503, configured to, in response to monitoring that the model training task for the target model is abnormal during execution, determine a faulty node from the device nodes, and determine an execution progress when the model training task for the target model is abnormal as a first progress:

a replacing module 504. configured to determine a backup node for the faulty node. continue to execute, by the backup node, a model training task for a sub-model deployed in the faulty node from the first progress, and monitor whether the faulty node returns to normal within a set period: and

a recovering and dividing module 505, configured to, in response to determining that the faulty node returns to normal within the set period. determine an execution progress of the backup node executing the model training task for the sub-model deployed in the faulty node when the faulty node returns to normal as a second progress, and continue to execute, by the faulty node. the model training task for the sub-model deployed in the faulty node from the second progress: in response to determining that the faulty node does not return to normal within the set period, re-divide the target model according to the number of normal device nodes to obtain re-divided sub-models, and deploy the re-divided sub-models respectively in the normal device nodes, to perform the model training task for the target model.

In some embodiments, the fault determining module 503 is configured to monitor whether heartbeat signals from the device nodes are received at default time intervals; in response to determining that a heartbeat signal transmitted by at least one of the device nodes is not received within a designated period, determine that the model training task for the target model is abnormal during execution, and determine a device node that does not transmit a heartbeat signal within the designated period as a faulty node.

In some embodiments. the replacing module 504 is configured to transmit a start signal to the backup node corresponding to the faulty node, such that after receiving the start signal, the backup node corresponding to the faulty node reads out the sub-model deployed in the faulty node that is locally pre-stored in the backup node, and continues to execute the model training task for the sub-model deployed in the faulty node from the first progress.

In some embodiments, the recovering and dividing module 505 is configured to, in response to determining that the faulty node returns to normal, according to execution progress information of the model training task for the target model carried by the heartbeat signal transmitted by the backup node, determine the execution progress of the backup node executing the model training task for the sub-model deployed in the faulty node, as the second progress; transmit model data of the sub-model deployed in the backup node to the faulty node, such that the faulty node updates a sub-model deployed in the faulty node according to the model data; and transmit a restart signal to the faulty node, such that after receiving the restart signal, the faulty node continues to execute the model training task for an updated sub-model deployed in the faulty node from the second progress.

In some embodiments, the recovering and dividing module 505 is configured to re-divide the target model according to the number of the normal device nodes, to obtain a dividing result; for each of the normal device nodes, based on the dividing result, determine a network layer in the target model that needs to be migrated to the device node as a supplementary network layer corresponding to the device node, and determine a current device node where the supplementary network layer corresponding to the device node is currently located as a network layer source node corresponding to the device node; and based on the supplementary network layer corresponding to each of the normal device nodes and the network layer source node corresponding to each of the normal device nodes, adjust a network layer currently contained in each of the normal device nodes, to deploy the re-divided sub-models respectively to the normal device nodes.

In some embodiments, the backup node is a predecessor node for the faulty node, and the predecessor node is configured to transmit a result of a forward calculation to the faulty node after completing the forward calculation of the sub-model deployed to the predecessor node.

The present disclosure further provides a computer-readable storage medium that stores computer programs, where the computer program may be configured to perform the method for training a distributed model based on node fault perception provided in FIG. 1.

The present disclosure further provides a schematic structural diagram of an electronic device corresponding to FIG. 1, as shown in FIG. 6. As shown in FIG. 6, at the hardware level, the electronic device includes a processor, an internal bus, a network interface, a memory, and a non-volatile memory, and may include hardware required for other operations. The processor reads the corresponding computer program from the non-volatile memory into the memory and then runs the computer program, to implement the method for training a distributed model based on node fault perception described in FIG. 1 above.

Of course, in addition to the software implementation, the present disclosure does not exclude other implementation methods, such as logic devices or a combination of hardware and software, etc. That is, the executive of the following processing process is not limited to individual logic units, but can also be hardware or logic devices.

In the 1990s, it was clear that improvements to a technology could be distinguished between hardware improvements (e.g., improvements to circuit structures such as diodes, transistors, switches, etc.) and software improvements (improvements to a method flow). However, with the development of technology. currently. the improvements of many method flows can be regarded as the direct improvements of the hardware circuit structures. Designers almost always get the corresponding hardware circuit structure by programming the improved method flow into the hardware circuit. Therefore, it cannot be said that a method flow improvement cannot be implemented with a hardware physical module. For example. a Programmable Logic Device (PLD) (e.g., Field Programmable Gate Array (FPGA)) is one such integrated circuit whose logic function is determined by user programming of the device. A digital system is “integrated” on a PLD by the designer's own programming. without the need for a chip manufacturer to design and manufacture a dedicated integrated circuit chip. Moreover. nowadays. instead of making IC chips manually. this programming is mostly implemented by “logic compiler” software, which is similar to the software compiler used for program development and writing. and the original code has to be written in a specific programming language before it is compiled. This is called Hardware Description Language (HDL), and there is not only one HDL, but many kinds. such as Advanced Boolean Expression Language (ABEL). Altera Hardware Description Language (AHDL), Confluence, Cornell University Programming Language (CUPL), HDCal, Java Hardware Description Language (JHDL), Lava, Lola, MyHDL, PALASM, Ruby Hardware Description Language (RHDL), etc. Currently, the most commonly used is Very-High-Speed Integrated Circuit Hardware Description Language (VHDL) and Verilog. It should also be clear to those skilled in the art that a hardware circuit implementing the logical method flow can be easily obtained by simply programming the method flow with a little logic in one of the above hardware description languages and programming the method flow into the integrated circuit.

The controller can be implemented in any suitable manner, for example, the controller can take the form of, for example, a microprocessor or processor and a computer readable medium storing computer readable program code (e.g. software or firmware) executable by the (micro) processor, logic gates, switches, Application Specific Integrated Circuit (ASIC), programmable logic controllers and embedded microcontrollers. Examples of the controllers may include, but are not limited to, the following microcontrollers: ARC 625D. Atmel AT91SAM, Microchip PIC18F26K20, and Silicone Labs C8051F320, and memory controllers may also be implemented as part of the control logic of the memory. It is also known to those skilled in the art that, in addition to implementing the controller in a purely computer readable program code manner, it is entirely possible to make the controller perform the same function in the form of logic gates, switches, specialized integrated circuits, programmable logic controllers, embedded microcontrollers, etc. by logically programming the method steps. Thus such a controller can be considered as a hardware component, and the devices included therein for implementing various functions can also be considered as structures within the hardware component. Or even, the apparatus for implementing various functions can be considered as both a software module for implementing a method and a structure within a hardware component.

The systems, apparatuses, modules, or units elucidated in the above embodiments can be implemented specifically by a computer chip or entity, or by a product with certain functions. An exemplary implementation device is a computer. Specifically, the computer may be, for example, a personal computer, a laptop computer, a cellular phone, a camera phone, a smart phone, a personal digital assistant, a media player, a navigation device, an email device, a gaming console, a tablet computer, a wearable device, or a combination of any of these devices.

For the convenience of description, the above devices are divided into various units according to their functions and described respectively. It is, of course, possible to implement the functions of each unit in the same or multiple software and/or hardware when implementing the present disclosure.

It should be understood by those skilled in the art that embodiments of the present disclosure may be provided as methods, systems, or computer program products. Accordingly, the present disclosure may take the form of an entirely hardware embodiment, an entirely software embodiment, or an embodiment combining software and hardware aspects. Furthermore, the present disclosure may employ the form of a computer program product implemented on one or more computer-usable storage media (including, but not limited to, disk storage, CD-ROM, optical storage, etc.), where the one or more computer-usable storage media having computer-usable program code.

the present disclosure is described with reference to flowcharts and/or block diagrams of methods, devices (systems), and computer program products according to embodiments of the present disclosure. It is to be understood that each process and/or block in the flowchart and/or block diagram, and the combination of processes and/or blocks in the flowchart and/or block diagram, may be implemented by computer program instructions. These computer program instructions may be provided to a processor of a general-purpose computer, a specialized computer, an embedded processor, or other programmable data processing device to produce a machine such that instructions executed by the processor of the computer or other programmable data processing device produce an apparatus for implementing a function specified in one or more processes of the flowchart and/or one or more blocks of the block diagram.

These computer program instructions may also be stored in a computer-readable memory capable of directing the computer or other programmable data processing device to operate in a particular manner such that the instructions stored in the computer-readable memory produce an article of manufacture including an instruction apparatus that implements the function specified in one or more processes of the flowchart and/or one or more blocks of the block diagram.

These computer program instructions may also be loaded onto a computer or other programmable data processing device such that a series of operational steps are executed on the computer or other programmable device to produce computer-implemented processing such that the instructions executed on the computer or other programmable device provide the steps used to perform the functions specified in one or more processes of the flowchart and/or one or more blocks of the block diagram.

In an exemplary configuration, the computing device includes one or more processors (CPUs), input/output interfaces, network interfaces, and memory.

Memory may include at least one of non-permanent storage in computer readable media, random access memory (RAM) or non-volatile memory, such as read only memory (ROM) or flash RAM. Memory is an example of a computer readable medium.

Computer readable media include permanent and non-permanent, removable and non-removable media that can be implemented by any method or technology to store information. Information may be computer readable instructions, data structures, modules of a program, or other data. Examples of storage media for computers include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read only memory (CDROM), digital versatile disc (DVD) or other optical storage, magnetic cartridge tape, magnetic tape magnetic disk storage, other magnetic storage device or any other non-transport medium that can be used to store information that can be accessed by a computing device. As defined herein, computer readable media does not include transitory computer readable media, such as modulated data signals and carriers.

It should also be noted that the term “comprise”, “include” or any other variation thereof is intended to cover non-exclusive inclusion, such that a process, method, article, or device that includes a set of elements includes not only those elements, but also other elements that are not explicitly listed, or other elements that are inherent to such a process, method, commodity, or device. Without further limitation, the element defined by the statement “including a . . . ” do not preclude the existence of additional identical elements in the process, method, article, or device that include the element.

It should be understood by those skilled in the art that embodiments of the present disclosure may be provided as methods, systems or computer program products. Accordingly. the present disclosure may take the form of an entirely hardware embodiment, an entirely software embodiment, or an embodiment combining software and hardware aspects. Furthermore, the present disclosure may employ the form of a computer program product implemented on one or more computer-usable storage media (including, but not limited to, disk storage, CD-ROM, optical storage, etc.), where the one or more computer-usable storage media having computer-usable program code.

The present disclosure may be described in the general context of computer-executable instructions executed by a computer, such as a program module. Generally, a program module includes routines, programs, objects, components, data structures, and the like that perform a specific task or implement a specific abstract data type. The present disclosure may also be practiced in distributed computing environments where tasks are performed by remote processing devices that are connected via a communication network. In distributed computing environments, program modules may be located in local and remote computer storage medium, including storage devices.

The various embodiments in the present disclosure are described in a progressive manner, and the same or similar parts between the various embodiments may be referred to each other, and each embodiment focuses on the differences from other embodiments. In particular, for a system embodiment, since it is basically similar to the method embodiment, the description is relatively simple, and for related parts, please refer to the partial description of the method embodiment.

The above description is only embodiments of the present disclosure and is not intended to limit the present disclosure. For those skilled in the art, various modifications and changes may be made in the present disclosure. Any modification, equivalent replacement, improvement, etc. present the spirit and principle of the present disclosure shall be included in the scope of the claims of the present disclosure.

1. A method for training a distributed model based on node fault perception, comprising:
determining a target model to be trained and dividing the target model into sub-models;
deploying the sub-models respectively in device nodes to perform a model training task for the target model through the device nodes;
in response to monitoring that the model training task for the target model is abnormal during execution, determining a faulty node from the device nodes, and determining an execution progress when the model training task for the target model is abnormal as a first progress;
determining a backup node for the faulty node, and continuing to execute, by the backup node, a model training task for a sub-model deployed in the faulty node from the first progress; and
monitoring whether the faulty node returns to normal within a set period;
in response to determining that the faulty node returns to normal within the set period, determining an execution progress of the backup node executing the model training task for the sub-model deployed in the faulty node when the faulty node returns to normal as a second progress, and continuing to execute, by the faulty node, the model training task for the sub-model deployed in the faulty node from the second progress;
in response to determining that the faulty node does not return to normal within the set period, re-dividing the target model according to the number of normal device nodes to obtain re-divided sub-models, and deploying the re-divided sub-models respectively in the normal device nodes, to perform the model training task for the target model.

2. The method according to claim 1, wherein monitoring that the model training task for the target model is abnormal during execution comprises:
monitoring whether heartbeat signals from the device nodes are received at default time intervals; and
in response to determining that a heartbeat signal transmitted by at least one of the device nodes is not received within a designated period, determining that the model training task for the target model is abnormal during execution, and determining a device node that does not transmit a heartbeat signal within the designated period as a faulty node.

3. The method according to claim 1, wherein continuing to execute, by the backup node, the model training task for the sub-model deployed in the faulty node from the first progress comprises:
transmitting a start signal to the backup node corresponding to the faulty node, such that after receiving the start signal, the backup node corresponding to the faulty node reads out the sub-model deployed in the faulty node that is locally pre-stored in the backup node, and continues to execute the model training task for the sub-model deployed in the faulty node from the first progress.

4. The method according to claim 1, wherein determining the execution progress of the backup node executing the model training task for the sub-model deployed in the faulty node when the faulty node returns to normal as the second progress, and continuing to execute, by the faulty node, the model training task for the sub-model deployed in the faulty node from the second progress comprises:
in response to determining that the faulty node returns to normal, according to execution progress information of the model training task for the target model carried by the heartbeat signal transmitted by the backup node, determining the execution progress of the backup node executing the model training task for the sub-model deployed in the faulty node, as the second progress;
transmitting model data of the sub-model deployed in the backup node to the faulty node, such that the faulty node updates a sub-model deployed in the faulty node according to the model data; and
transmitting a restart signal to the faulty node, such that after receiving the restart signal, the faulty node continues to execute the model training task for an updated sub-model deployed in the faulty node from the second progress.

5. The method according to claim 1, wherein re-dividing the target model according to the number of the normal device nodes to obtain the re-divided sub-models, and deploying the re-divided sub-models respectively in the normal device nodes comprises:
re-dividing the target model according to the number of the normal device nodes, to obtain a dividing result;
for each of the normal device nodes, based on the dividing result, determining a network layer in the target model that needs to be migrated to the device node as a supplementary network layer corresponding to the device node, and determining a current device node where the supplementary network layer corresponding to the device node is currently located as a network layer source node corresponding to the device node; and
based on the supplementary network layer corresponding to each of the normal device nodes and the network layer source node corresponding to each of the normal device nodes, adjusting a network layer currently contained in each of the normal device nodes, to deploy the re-divided sub-models respectively to the normal device nodes.

6. The method according to claim 1, wherein the backup node is a predecessor node for the faulty node, and the predecessor node is configured to transmit a result of a forward calculation to the faulty node after completing the forward calculation of the sub-model deployed to the predecessor node.

7-12. (canceled)

13. A computer readable storage medium, wherein the storage medium stores a computer program, and the computer program when executed by a processor achieves a method according to claim 1.

14. An electronic device comprising a memory, a processor and a computer program stored on the memory and runnable on the processor, wherein the processor, when the program is executed by the processor, achieves a method according to claim 1.
